(19) United States
(12) Patent Application Publication
(10) Pub. No.: US 2008/0142616 A1
(43) Pub. Date: Jun. 19, 2008

(54) Method of Producing a Directed Spray

(75) Inventor: Eilaz Babaev, Minnetonka, MN (US)

Correspondence Address: Bacoustics, LLC, 5929 BAKER ROAD, SUITE 470, MINNETONKA, MN, 55345, US

(73) Assignee: BACOUSTICS LLC, Minnetonka, MN (US)

(21) Appl. No.: 11/611,543

(22) Filed: Dec. 15, 2006

(51) Int. Cl. B05B 1/02

(52) U.S. Cl. 239/102.1

(57) ABSTRACT

The present invention relates to a method of utilizing ultrasound to atomize a liquid comprising the steps of inducing ultrasonic vibrations within a solid member, delivering a liquid to be atomized to a surface of said member from which ultrasonic waves radiate from said member (hereafter referred to as a “radiation surface”), and allowing the liquid delivered to said radiation to be atomized and propelled away from said member. Delivering the liquid to be atomized to the radiation surface of the vibrating member may comprise the steps placing the liquid on a side of the vibrating member and allowing the liquid to be carried by the ultrasonic waves traveling through the vibrating member to a radiation surface. Alternatively, delivering the liquid to be atomized to a radiation surface of the vibrating member may comprise the step of passing the liquid through a channel opening within a radiation surface. The resulting spray emitted from the radiation surface may comprise small droplets of the delivered liquid, wherein the droplets are highly uniform in size throughout the resulting spray. The atomized spray produced may be focused by increasing the amplitude of the ultrasonic waves traveling through the vibrating member. Conversely, decreasing the amplitude of the ultrasonic waves traveling through vibrating member may widen the atomized spray produced. The atomized spay may also be focused by the geometric configuration of the radiation surface.

### BACKGROUND OF THE INVENTION

The present invention relates to a method of utilizing ultrasound to atomize a liquid.

The present invention relates to a method of utilizing ultrasound to create a directed spray of an atomized liquid.

The present invention relates to a method of utilizing ultrasound to produce and release of a consistent spray of an atomized liquid into an environment, despite changes in the pressure of the environment into which the atomized spray is injected.

Liquid atomization is the process by which a quantity of liquid is broken apart into small droplets, also referred to as particles. Methods of liquid atomization have been utilized in a variety of applications. For instance, liquid atomization has been utilized to apply various coatings to devices. Gasoline is injected into most modem engines by use of liquid atomization, often referred to as fuel injection. Delivering therapeutic substances to the body as to treat asthma or wounds is often accomplished by first atomizing the therapeutic solution.

Traditional methods of liquid atomization; such as those generally employed in fuel injection, utilize pressure to disperse a liquid into smaller droplets. Atomization is accomplished by forcing a pressurized liquid through small orifices opening into a lager area. As the liquid passes from the small orifice into the larger area, the liquid increases in volume. Conceptually, this is similar to the inflation of a balloon and can be represented by the equation:

$$Volume = \frac{( A constant , k ) \times ( Area outside the orifice )}{( Force pushing the liquid through the orifice )}$$

According to the above equation, as the area into which a liquid is forced gets larger the volume of the liquid begins to increase. Thus as the liquid initially exits from the small orifice of a typical fuel injector, the liquid forms an expanding drop very similar to an inflating balloon. The liquid exiting from the injector is initially retained in the drop by the surface tension of the liquid on the surface of the drop, which is conceptually similar to the elastic of a balloon. Surface tension is created by the attraction between the molecules of the liquid located at the surface of the drop. As the volume of the liquid increases, the drop at the injector's orifice begins to expand. Expansion of the drop moves the molecules at the surface of the drop farther away from each other. Eventually, the molecules on the surface of the drop move far enough away from each other as to break the attractive forces holding the molecules together. When the attractive forces between the molecules are broken, the drop explodes like an over inflated balloon. Explosion of the drop releases several smaller droplets, thereby atomizing the liquid.

Liquid atomization can also be accomplished through the use of ultrasound. Exposing the liquid to be atomized to ultrasound creates ultrasonic vibration within the liquid. The vibrations within the liquid cause molecules on the surface of the liquid to move about, disrupting the surface tension of the liquid. Disruption of the liquid's surface tension creates areas on the surface of the liquid with reduced or no surface tension, which are very similar to holes in a sheave, through which droplets of the liquid can escape. Devices utilizing this phenomenon to create a fog or mist are described in U.S. Pat. No. 7,017,282, U.S. Pat. No. 6,402,046, U.S. Pat. No. 6,237,525, and U.S. Pat. No. 5,922,247.

Disrupting the surface tension of a liquid with ultrasonic vibrations can also be utilized to expel a liquid through small orifices through which the liquid would not otherwise flow. Prior to ultrasound exposure, the surface tension of the liquid holds the liquid back, like a dam, preventing it from flowing through the small channels. Exposing the liquid to ultrasound causes the liquid's molecules to vibrate, thereby disrupting the surface tension dam and allowing the liquid to flow through the orifice. This method of liquid atomization is employed in inkjet print cartilages and the devices described in U.S. Pat. No. 7,086,617, U.S. Pat. No. 6,811,805, U.S. Pat. No. 6,845,759, U.S. Pat. No. 6,739,520, U.S. Pat. No. 6,530,370, and U.S. Pat. No. 5,996,903.

Ultrasonic vibrations have also been utilized to enhance liquid atomization in pressure atomizers such as fuel injectors. Again, the introduction of ultrasonic vibrations disrupts or weakens the surface tension holding the liquid together, making the liquid easier to atomize. Thus, exposing the liquid to ultrasonic vibrations as the liquid exits a pressure atomizer reduces the amount of pressure needed to atomize the liquid and/or allows for the use of a larger orifice. Injection devices utilizing ultrasound in this manner are described in U.S. Pat. No. 6,543,700, U.S. Pat. No. 6,053,424, U.S. Pat. No. 5,868,153, and U.S. Pat. No. 5,803,106.

Methods of liquid atomization relying on pressure, in whole or in part, are sensitive to pressure changes in the environment into which the atomized liquid is to be injected. If the pressure of the environment increases, the effective pressure driving liquid atomization decreases. The decrease in the effective pressure driving and/or assisting liquid atomization occurs because the pressure within the environment pushes against the liquid as the liquid exits the orifice, thereby hindering atomization. Conversely, if the pressure of the environment into which the atomized liquid is injected decreases, the effective pressure driving and/or assisting liquid atomization increases.

Ultrasonic waves traveling through a solid member, such as a rod, can also be utilized to atomize a liquid and propel the atomized liquid away from the member. Such methods of liquid atomize require dripping or otherwise placing the liquid to be atomized on the rod as ultrasonic waves travel through the rod. Clinging to the rod, the liquid is transported to the end of the rod by the ultrasonic vibrations within the rod. An everyday example of this phenomenon is a person attempting to pour water from a glass by holding the glass at a slight angle. Instead of the water pouring out of the glass and dropping straight down to the floor, the water clings to and runs along the external sides of the glass before falling from the glass to the floor. Similarly, the liquid to be atomized clings to the sides of an ultrasonically vibrating rod as the liquid is carried towards the end of the rod by ultrasonic waves traveling through the rod. Ultrasonic waves emanating from the tip of rod atomize and propel the liquid forward, away from the tip. Devices utilizing ultrasonic waves to atomize liquids in such a manner are described in U.S. Pat. No. 6,761,729, U.S. Pat. No. 6,706,337, U.S. Pat. No. 6,663,554, U.S. Pat. No. 6,569,099, U.S. Pat. No. 6,247,525, U.S. Pat. No. 5,970,974, U.S. Pat. No. 5,179,923, U.S. Pat. No. 5,119,775, and U.S. Pat. No. 5,076,266.

When attempting to atomize liquids in such a manner, care must be utilized in delivering the liquid to the vibrating rod. For instance, if the liquid is dropped from to high of a point a majority of the liquid will bounce off the rod. The devices depicted in U.S. Pat. No. 5,582,348, U.S. Pat. No. 5,540,384, and U.S. Pat. No. 5,409,163 utilize a meniscus to gently deliver liquid to a vibrating rod. The meniscus holds the liquid to be atomized between the vibrating rod and the delivery device by the attraction of the liquid to the rod and the delivery device. As described in U.S. Pat. No. 5,540,384 to Erickson et al., creation of a meniscus requires careful construction and design of the liquid delivery device.

Furthermore, if the delivery pressure of the liquid changes, the meniscus may be lost. For instance, if the delivery pressure suddenly increases, the liquid may become atomized before a meniscus can be formed. Destruction of the meniscus may also occur if the pressure outside the liquid delivery device suddenly changes. Thus, use of a meniscus to deliver a liquid to be atomized to a vibrating rod is generally limited to situations where the construction of the device, the design of the device, and the environment in which the device is used can be carefully monitored and controlled.

According there is a need for a method of liquid atomization enabling the production and release of a consistent spray of an atomized liquid into an environment, despite changes in the pressure of the environment into which the atomized spray is injected.

### SUMMARY OF THE INVENTION

The present invention relates to a method of utilizing ultrasound to atomize a liquid comprising the steps of inducing ultrasonic vibrations within a solid member, delivering a liquid to be atomized to a surface of said member from which ultrasonic waves radiate from said member (hereafter referred to as a “radiation surface”), and allowing the liquid delivered to said radiation to be atomized and propelled away from said member. Delivering the liquid to be atomized to the radiation surface of the vibrating member may comprise the steps placing the liquid on a side of the vibrating member and allowing the liquid to be carried by the ultrasonic waves traveling through the vibrating member to a radiation surface.

Alternatively, delivering the liquid to be atomized to a radiation surface of the vibrating member may comprise the step of passing the liquid through a channel opening within a radiation surface. The resulting spray emitted from the radiation surface may comprise small droplets of the delivered liquid, wherein the droplets are highly uniform in size throughout the resulting spray. The atomized spray produced may be focused by increasing the amplitude of the ultrasonic waves traveling through the vibrating member. Conversely, decreasing the amplitude of the ultrasonic waves traveling through vibrating member may widen the atomized spray produced. The atomized spay may also be focused by the geometric configuration of the radiation surface.

Delivering the liquid to be atomized to the vibrating member may be accomplished by gently dripping, trickling, or otherwise inducing a liquid to flow over and/or onto a side of the vibrating member. Utilizing a phenomenon similar to capillary action, the ultrasonic waves passing through the vibrating member pull the liquid to be atomized towards the radiation surface of the vibrating member. An everyday example of this phenomenon is a person attempting to pour water from a glass by holding the glass at a slight angle. Instead of the water pouring out of the glass and dropping straight down to the floor, the water clings to and runs along the external sides of the glass before falling from the glass to the floor. Similarly, the liquid to be atomized clings to the sides of the vibrating member as the liquid is carried towards the radiation surface by the ultrasonic waves traveling through the vibrating member. Upon reaching the radiation surface, ultrasonic waves emanating from the radiation surface atomize and propel the liquid forward, away from the vibrating member.

The distance between the radiation surface and the point of liquid delivery to the vibrating member should by sufficiently short as to prevent an unacceptable amount of the liquid to be atomized from falling off the vibrating member before it reaches the radiation surface. The distance the liquid to be atomized will travel along the vibrating member before falling off is dependent upon, among other things, the conformation of the vibrating member, the volume of liquid traveling along the vibrating member, the orientation of the vibrating member, and the attraction between the liquid and the vibrating member. The proper distance can be experimentally determined in the following manner. Ultrasonic waves are passed through a vibrating member, ideally, conforming to the intended geometric conformation and composed of the material intended to be utilized in devices and/or procedures employing the method of the present invention. The liquid to be atomized is then applied to the vibrating member at a point close to the radiation surface. The point at which the liquid is applied to the vibrating member is successively moved away from the radiation surface until an unacceptable amount of the liquid begins to fall off the vibrating member.

The distance between the radiation surface and the point just before the point at which an unacceptable amount of the liquid applied to the vibrating member fell off the vibrating member before reaching the radiation surface is an allowable distance between the radiation surface and the point of liquid delivery, with respect to the liquid and volume of liquid tested. If the orientation of the vibrating member is expected to change, the above procedure should be repeated with the vibrating member at several orientations and the shortest distance obtained should be used.

Movement of the liquid away from the point of delivery and towards the radiation surface of the vibrating member may be assisted by placing the point of liquid delivery on an antinode of the ultrasonic waves passing through the vibrating member. Delivering the liquid to be atomized to the sides of the vibrating member may also be accomplished by placing an orifice from which a pressurized liquid is expelled at a distance away from a side of the vibrating member. As the pressurized liquid leaves the orifice it enters the larger arm of the space between the orifice and the vibrating member, thereby causing the volume of the liquid to expand like a balloon. Before the volume of the liquid becomes large enough to break the surface tension of the liquid thereby causing the liquid to atomize, the liquid comes into contact with the vibrating member. Carrying the liquid away from the point at which the expanding drop of liquid contacts the vibrating member, the ultrasonic waves passing through the vibrating member prevent further expansion of the drop, similar to a leak in a balloon. Mathematically, this effect can be represented by the following equation:

$$Volume = \frac{\begin{matrix}( number molecules of the liquid present ) \times \\ ( area ) \times ( a constant )\end{matrix}}{( force acting of the liquid )}$$

Thus, as the number of molecules within the expanding drop of liquid decreases the volume of the drop decreases, or at least stops expanding. Carrying liquid out of the drop and towards the radiation surface, the ultrasonic waves passing through the vibrating member decrease the number of the molecules within the drop. If the drop formed from the liquid released from the orifice stops expanding before the volume of the drop becomes large enough to break the liquid's surface tension, the liquid will not atomize as it is released from the orifice. Instead, a liquid conduit will be created between the orifice and the vibrating member through which a liquid may be pulled from the orifice, down the vibrating member, and towards the radiation surface. Upon reaching the radiation surface, the liquid is atomized and propelled away from the vibrating member by ultrasonic waves emanating from the radiation surface. Thus, ultrasonic waves traveling through the vibrating member drive liquid delivery to the radiation surface, atomization at the radiation surface, and the ejection of the atomized liquid from the vibrating member. The resulting spray emitted from the radiation surface may comprise small droplets of the delivered liquid, wherein the droplets are highly uniform in size throughout the resulting spray.

The distance between the liquid delivery orifice and the vibrating member should be such that the drop of the pressurized liquid leaving the orifice contacts the vibrating member before the drop expands to a size sufficient to break the surface tension of the liquid at the surface of the drop. The distance between the liquid delivery orifice and the vibrating member is dependent upon, among other things, the surface tension of the liquid to be atomized and the conformation of the liquid delivery orifice. However, the distance between the liquid delivery orifice and the vibrating member can be, experimentally determined in the following manner. Ultrasonic waves are passed through a vibrating member, ideally, conforming to the intended geometric conformation and composed of the material intended to be utilized in devices and/or procedures employing the method of the present invention. An orifice conforming to the intended conformation of the delivery orifice to be utilized is then placed in close proximity to the vibrating member. The liquid to be atomized is then forced through the orifice with the maximum liquid delivery pressure expected to be utilized. Ideally, the test should be performed within an environment with a pressure at, exceeding, and/or below the pressure of the environment in which the method of the present invention is expected to be performed. The orifice is then moved away from the vibrating member until the liquid ejected from the orifice begins to atomize. The maximum distance between the vibrating member and the delivery orifice will be the point just before the point liquid ejected from the orifice began to atomize. If the orientation of the vibrating member is expected to change during operation of the present invention, the above procedure should be repeated with the vibrating member at several orientations and the shortest distance obtained should be used. If the liquid ejected from the orifice atomizes when the orifice is located at the closest possible point to the vibrating member, then the amplitude of the ultrasonic waves traveling through the vibrating member should be increased, the pressure forcing the liquid through the orifice should be decreased, and/or the pressure within the environment increased, and the experiment repeated.

Alternatively, the liquid to be atomized may be delivered to the radiation surface of the vibrating member by passing the liquid through a channel opening within the radiation surface of the vibrating member. Moving the liquid to be atomized through the channel may be accomplished by applying a force to the liquid such as, but not limited to, the pressure generated by a pump or the force of gravity acting on the liquid. If the channel runs through the vibrating member, the induced ultrasonic vibration of the vibrating member may be utilized to move the liquid to be atomized through the channel. As the liquids exits the channel, its spreads about the radiation surface as to establish a liquid conduit and becomes atomized by the ultrasonic waves emanating from the radiation surface. However, if the movement of the liquid through the channel is induced by pressurizing the liquid, atomization of the liquid may be accomplished by allowing the pressurized liquid to exit the orifice within the radiation surface.

Once a liquid conduit has been created, the conduit will be preserved despite changes in the pressure of the environment into which the atomize liquid is sprayed. Furthermore, once the liquid conduit has been created, liquid delivery to the radiation surface becomes driven by the ultrasonic waves passing through the vibrating member. When the delivered liquid reaches the radiation surface, the liquid is transformed into an atomized spray by the ultrasonic waves passing through the vibrating member and emanating from the radiation surface. Consequently, liquid delivery and atomization, once the liquid conduit has been established, is accomplished in a pressure independent manner and thus is relatively unaffected by changes in pressure within the environment into which the atomized liquid is injected. However, if the pressure within the environment into which the atomized liquid is injected becomes greater, by some factor, than the pressure driving liquid delivery, then the liquid conduit will eventually dissipate.

As liquid delivery to the vibrating member and movement of the liquid along the vibrating member, towards the radiations surface, is driven by ultrasonic waves passing through the vibrating member once a liquid conduit has been established, increasing the rate at which liquid is delivered to the vibrating member and flows towards the radiation surface may be accomplished by increasing the amplitude of the ultrasonic waves passing through the vibrating member. Therefore, increasing the amplitude of the ultrasonic waves passing through the vibrating member allows a larger volume of atomized liquid to be expelled from the radiation surface per unit time. Conversely, decreasing the amplitude of the ultrasonic wave passing through the vibrating member may decrease the rate of flow, thereby reducing the volume of atomized liquid ejected from the radiation surface per unit time. Increasing the amplitude of the ultrasonic waves passing through the vibrating member may also adjust the width of the spray pattern. Consequently, increasing the amplitude of the ultrasonic waves may narrow the spray pattern while increasing the flow rate; delivering a larger, more focused, volume of liquid. Changing the geometric conformation of the radiation surface may also alter the shape of the emitted spray pattern and may prove useful.

Creating a directed spray of the atomized liquid may be accomplished by utilizing the ultrasonic waves emanating from the radiation surface of the vibrating member to focus the spray pattern. Ultrasonic waves emanating from the radiation surface may direct and confine the vast majority of the atomized spray produced to the outer boundaries of the radiation surfaces. Consequently, the majority of the spray produced may be initially confined to the geometric boundaries of the radiation surface. Therefore, producing a roughly column-like spray pattern may be accomplished by utilizing a vibrating member with a flat face. Generating a spray pattern with a width smaller than the width of the vibrating member may be accomplished by utilizing a vibrating member with a tapered radiation surface. Further focusing the spray ejected from the radiation surface may be accomplished by utilizing a vibrating member with a concave radiation surface. In such a configuration, ultrasonic waves emanating from the concave radiation surface may focus the spray through the focal point of the radiation surface. If it is desirable to focus, or concentrate, the spray produced towards the inner boundaries of the radiation surface, but not towards a specific point, then utilizing a vibrating member with a radiation surface with slanted portions facing the axis of the vibrating member may be desirable. Ultrasonic waves emanating from the slanted portions of the radiation surface may direct the atomized spray inwards, towards the axis of the radiation surface. There may, of course, be instances where a focused spray is not desirable. For instance, it may be desirable to quickly apply an atomized liquid to a large surface area. In such instances, utilizing a vibrating member with a convex radiation surface may produce a spray pattern with a width wider than that of the vibrating member. Ultrasonic waves emanating from a convex radiation surface may direct the spray radially and longitudinally away from radiation surface. The radiation surface of the vibrating member utilized may possess any combination of the above mentioned configurations such as, but not limited to, an outer concave portion encircling an inner convex portions and/or an outer planer portion encompassing an inner conical portion.

Inducing resonating vibrations within the vibrating member facilitates production of the spray patterns described above. If the spray exceeds the geometric bounds of the radiation surface, i.e. is fanning to wide, when the member is vibrated in resonance, increasing the amplitude of the ultrasonic vibrations of the vibrating member may narrow the spray. Conversely, if the spray is too narrow, then decreasing the amplitude of the ultrasonic vibrations may widen the spray.

When the method of the present invention is utilized to deliver gasoline into an engine, it provides several advantageous results. Finely atomizing and energizing gasoline delivered to the engine, the method of the present invention improves combustion of the gasoline while drastically reducing the amount of harmful emissions produced. Thus, constructing a fuel injector utilizing the method of the present invention may result in the gasoline delivered into an engine being almost, if not, completely consumed and cleanly burned. Furthermore, injectors utilizing the method of the present invention may enable the mixing of water and gasoline as to create a hybrid fuel that burns better than pure gasoline. Thus the method of the present invention, when incorporated into a fuel injector, may reduce the production of harmful emissions and gasoline consumption by the engine.

The method of the present invention may also separate liquids from solids, liquids, gases, or any combination thereof (hereafter collectively referred to as “material” or “material component”) suspended and/or dissolved within the liquid to be atomized By way of example, the method of the present invention may be utilized to separate plasma from blood. Plasma is the liquid portion of blood and may be utilized to produce several therapeutic products. As the liquid containing the suspended and/or dissolved material comes in contact with the radiation surface of the vibrating member, ultrasonic waves emanating from the radiation surface atomize the liquid and push the atomized liquid and/or the material suspended and/or dissolved within the liquid away from the radiation surface. The distance away from the radiation surface the liquid and suspended and/or dissolved material travel before landing depends upon the mass of the liquid droplets and the mass of the suspended and/or dissolved material. The ultrasonic waves emanating from the radiation surfaces impart the same amount energy on both the liquid droplets and the suspended and/or dissolved material. However, the velocity at which the liquid droplets and suspended and/or dissolved material leave the radiation surfaces is dependent upon the mass of the liquid droplets and the mass of the suspended and/or dissolved material present. The less massive a droplet or suspended and/or dissolved material the higher the velocity at which the droplet or material leaves the radiation surface. The relationship between mass and departing velocity can be represented by the following equation:

$$Departing Velocity = Square Root of \text{:} \frac{\begin{matrix}( Energy of emitted \\ Ultrasonic Wave )\end{matrix} }{( Mass of Droplet or Material}$$

Generally, the droplets of the liquid will be less massive than the material suspended and/or dissolved within the liquid. Consequently, the liquid droplets will generally have a higher departing velocity than the suspended and/or dissolved material. However, both the liquid droplets and the suspended and/or dissolved material will fall towards the ground at the same rate. The distance the droplets or suspended and/or dissolved material travel before hitting the ground increases as the velocity at which the droplets or suspended and/or dissolved material leave the radiation surface increases. Therefore, the less massive droplets will travel farther than more massive suspended and/or dissolved material before falling to the ground. Thus, the liquid and material suspended and/or dissolved within the liquid may be separated based on the distance away from the radiation surface each travels.

In addition to separating material on the basis of mass, the present invention may also be utilized to separate material on the basis of boiling point. For instance, if the liquid to be atomized contains several liquids mixed together, the present invention may be used to separate the liquids. The liquid containing the liquids to be separated is atomized and heated to a temperature above the boiling point of at least one of the liquids. For example, assume that the liquid contains ethanol and water and the removal of the water from the ethanol is desired. Separating the water from the ethanol could be accomplished by heating the liquid mixture to a temperature of at least 78.4° C., the boiling point of ethanol, but below 100° C., the boiling point of water, atomizing the liquid, and allowing the evaporated ethanol to escape from the atomized spray. Heating the liquid mixture could be accomplished by injecting the atomized spray of the mixture into an environment with a temperature at or above 78.4° C. and below 100° C. Atomized into a spray of small droplets, the liquid will quickly approach the temperature of the environment. Alternatively, passing the atomized spray of the mixture by a source of heat such as, but not limited to, a flame or lamp may also heat the liquid mixture to the desired temperature. When the temperature of the liquid spray reaches the boiling point of ethanol, the ethanol will evaporate out of the small droplets. The droplets may then be collected in a container. The evaporated ethanol may be collected as a gas and/or allowed to condense and collected as a liquid. The liquid mixture may also be heated to the desired temperature prior to atomization and the ethanol gas allowed to escape from the liquid mixture during and/or after atomization.

The method of the present invention may further comprise the additional steps of monitoring the amount of material ejected from the radiation surface and/or controlling the amount liquid delivered to the radiation surface. Monitoring the amount of material ejected from the radiation surface and controlling the amount of liquid delivered to the radiation suffice enables the amount and/or ratio of liquid atomized and/or mixed by the method of the present invention to be adjusted and/or controlled during production of the atomized spray. This may prove advantageous when the liquid atomized and/or material dissolved and/or suspended within the liquid atomized are reagents in a chemical reaction occurring after the material is ejected from the radiation surface of the vibrating member, such as, but not limited to, combustion. Optimizing the efficiency of a chemical reaction requires maintaining a proper ratio of the reagents taking part in and/or consumed by the reaction. Considering combustion as an example of a chemical reaction, a source of carbon such as, but not limited to, gasoline is reacted with oxygen producing heat, or energy, carbon monoxide, carbon dioxide, and water. Both the amount of oxygen and gasoline present limit the amount of energy produced. For instance, if the amount of gasoline present exceeds the amount of oxygen present, then the amount of gasoline burned, and consequently that amount of energy produced, will be restricted by the amount of oxygen present. Thus, if the there is not enough oxygen present, then all of the gasoline ejected from the radiation surface will not be burned and is therefore wasted. Conversely, if the amount of oxygen present exceeds the amount of the gasoline present, then all of the gasoline will be consumed and converted into energy. Monitoring the amount of reagents consumed by the reaction, the amount of product produced by the reaction, the amount of reagent present before and/or after the reaction occurs, and/or any combination thereof enables individuals using the method of the present invention to respond to an excess of a reagent by alternating the amount of the liquid containing the reagent in excess that is delivered to the radiation surface. Reducing the amount of the liquid containing the reagent in excess that is delivered to the radiation surface reduces the amount of the excess reagent present and/or reduces the amount of unwanted product produced. Alternatively, increasing the amount of the liquid containing the reagent not in excess that is delivered to the radiation surface decreases the amount of excess reagent not consumed by the reaction and/or reduces the amount of unwanted product produced.

The method of the present invention may also be utilized to combine liquids. If different liquids are flowed over a vibrating member, they will combine at the radiation as the liquids are atomized.

Ultrasonic waves passing through the vibrating member may have a frequency of approximately 16 kHz or greater and an amplitude of approximately 1 micron or greater. It is preferred that the ultrasonic waves passing through the vibrating member have a frequency between approximately 20 kHz and approximately 200 kHz. It is recommended that the frequency of the ultrasonic waves passing through the vibrating member be approximately 30 kHz.

One aspect of the present invention may be to provide a means producing a consistent spray of an atomized liquid in an environment, despite changes in the pressure of the environment.

Another aspect of the present invention may be to provide a means releasing a consistent spray of an atomized liquid into an environment, despite changes in the pressure of the environment.

Another aspect of the present invention may be to enable the creation of highly, atomized, continuous, uniform, and/or directed spray.

Another aspect of the present invention may be to enable interrupted atomization of liquid and use of the atomized liquid to produce a coating.

Another aspect of the present invention may be to enable interrupted atomization of liquid and use of the atomized liquid to produce a coating of a controllable thickness and free from webbing and stringing.

Another aspect of the present invention may be to provide a means of mixing liquids.

Another aspect of the present invention may be to enable the mixing of two or more unmixable liquids.

Another aspect of the present invention may be to provide a means of Mixing liquids as the liquids atomized as to produce a hybrid liquid spray.

Another aspect of the present invention may be to enable interrupted mixing and/or atomization of different liquids and use of the mixed liquid to produce a coating on a device of a controllable thickness and free from webbing and stringing.

Another aspect of the present invention may be to enable continuous mixing and/or atomization of different liquids and use of the mixed liquid to produce a coating on a device of a controllable thickness and free from webbing and stringing.

Another aspect of the present invention may be to enable creation of a hybrid water-gasoline fuel.

Another aspect of the present invention may be to reduce the amount of harmful emissions created from the combustion of gasoline within an engine.

Another aspect of the present invention may be to enhance the combustion of gasoline injected into an engine.

Another aspect of the present invention may be to provide a means of separating liquids from material suspended and/or dissolved within the liquid.

These and other aspects of the invention will become more apparent from the written description and figures below.

### BRIEF DESCRIPTION OF THE DRAWINGS

The present invention will be shown and described with reference to the drawings of preferred embodiments and clearly understood in details.

FIG. 1 depicts a flow chart of one embodiment of the method of the present invention.

FIG. 2 illustrates cross sections of alternative geometric conformations of radiation surfaces that may be used to focus an atomized spray.

### DETAILED DESCRIPTION OF THE INVENTION

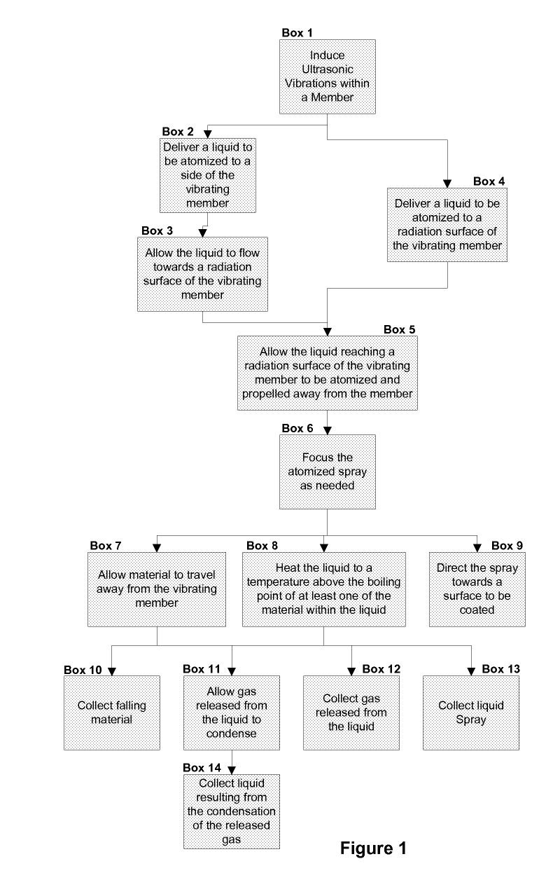

FIG. 1 depicts a flow chart of one embodiment of the method of the present invention. As indicated by Box 1, the method begins by first inducing a solid member to ultrasonically vibrate at or near the resonant frequency of the solid member. The liquid to be atomized is then delivered to a side of the vibrating member, as indicated by Box 2. Delivering the liquid to a side of the vibrating member may be accomplished by dripping, trickling, or otherwise inducing a liquid to flow over and/or onto a side of the vibrating member. Alternatively, delivering the liquid to a side of the vibrating member may be accomplished by positioning an orifice at a distance from the vibrating member such that a drop of the liquid exiting the orifice contacts the vibrating member before atomizing. After being delivered to a side of the vibrating member, the liquid to be atomized is then allowed to flow towards a radiation surface of the vibrating member, as indicated by Box 3. The liquid reaching a radiation surface of the vibrating member the liquid is then allowed to be atomized and propelled away from the vibrating member, as to generate an atomized spray, as indicated by Box 5.

The liquid to be atomized may also be directly applied to the radiation surface, as indicated by Box 4. Direct application of the liquid to be atomized to the radiation surface may be accomplished by the method described above with respect to the application of the liquid to a side of the vibrating member. Alternatively, passing the liquid to be atomized through a channel opening within the radiation surface may enable delivery of the liquid to the radiation surface. If a channel is used to deliver the liquid to the radiation surface, the liquid may be atomized as the liquid exits the channel and/or before the liquid exits the channel.

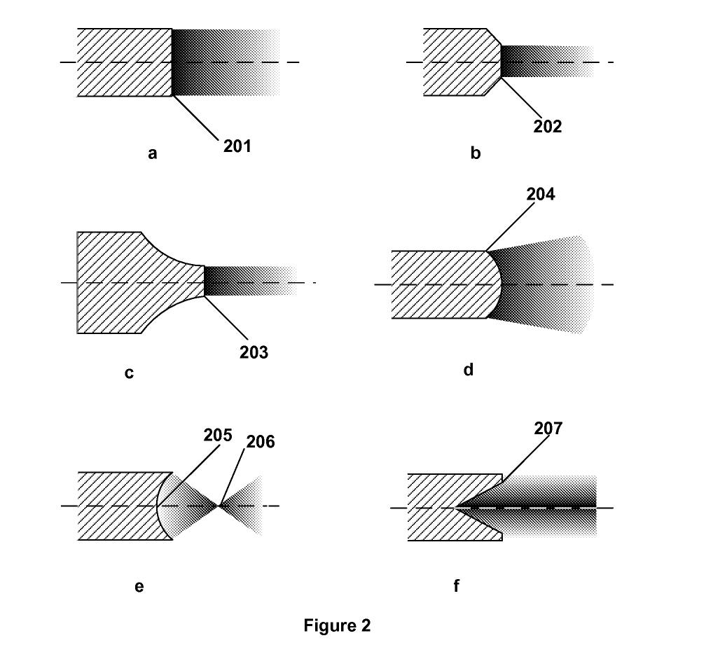

After the liquid has been atomized and propelled away from the radiation surface of the vibrating member, the atomized spray is focused as needed, as indicated by Box 6. Focusing the atomized spray may be accomplished by adjusting the amplitude of the ultrasonic waves passing through the vibrating member and/or by changing the geometric conformation of the radiation surface. FIG. 2 illustrates alternative geometric conformations of radiation surfaces that may be used to focus the atomized spray. FIGS. 2a, and b, and c depict radiation surfaces 201, 202, and 203 comprising a flat face and producing a roughly column-like spray pattern. The radiation surface may also be tapered, as depicted in FIGS. 2b and 2c. Ultrasonic waves emanating from the radiation surfaces 201, 202, and 203, depicted in FIGS. 2a, b, and c, direct and confine the vast majority of the atomized spray to the outer boundaries of the radiation surfaces' flat faces. Consequently, the majority of the spray in FIGS. 2a, c, and b; is initially confined to the geometric boundaries of radiation surfaces 201, 202, and 203. The ultrasonic waves emitted from the convex radiation surface 204, depicted in FIG. 2d, directs the spray radially and longitudinally away from radiation surface 204. Conversely, the ultrasonic waves emanating from the concave radiation surface 205, depicted in FIG. 2e, focus the spray through focal point 206. The radiation surface may also possess a conical configuration as depicted in FIG. 6f. Ultrasonic waves emanating from the slanted portions of radiation surface 207, depicted in FIG. 6f, direct the atomized spray inwards. The radiation surface of the ultrasound tip may possess any combination of the above mentioned configurations such as, but not limited to, an outer concave portion encircling an inner convex portions and/or an outer planer portion encompassing an inner conical portion.

If the spray exceeds the geometric bounds of the radiation surface, i.e. is fanning to wide, increasing the amplitude of the ultrasonic waves passing through the vibrating member may narrow the spray. Conversely, if the spray is to narrow, then decreasing the amplitude of the ultrasonic waves passing through the vibrating member may widen the spray. Both widening and narrowing the atomized spray should be regarded as focusing the atomized spray.

Returning to FIG. 1, material may then be allowed to travel away from the radiation surface of the vibrating member, as indicated by Box 7. It may be preferable to allow the material to travel a sufficient distance such that differences in the velocities at which different material present within the liquid to be atomize leave the radiation surface can be detected by how far the different material travel before falling to the ground. In the alternative or in combination, it may be preferable to heat the atomized spray traveling away from the radiation surface to a temperature of at least the boiling point of one of the material present within the spray, as indicated by Box 8. Heating the atomized spray may be accomplished by passing the spray through an environment with a temperature above the boiling point of at least one of the material present. Alternatively, the atomized spray may be heated by passing the spray near a heat source such as, but not limited to, a flame or lamp. In alternative to or in combination, the atomized spray, as indicated by Box 9, may also be directed towards a surface and allowed to accumulate on the surface as to coat the surface with material within the atomized spray.

After allowing the atomized spray to travel away from the radiation surface and/or heating the spray, falling material may be collected, as indicated by Box 10. Gases released from the atomized spray and/or from the liquid during atomization may also be collected, as indicated by Box 12. Gases released may be allowed to condense, as indicated by Box 11, and the resulting liquid collected, as indicated by Box 14. In addition to collecting falling material and/or gases, the atomized liquid spray may also be collected, as indicated by Box 15.

Although specific embodiments have been illustrated and described herein, it will be appreciated by those of ordinary skill in the art that any arrangement that is calculated to achieve the same or similar purpose may be substituted for the specific embodiments. It is to be understood that the above description is intended to be illustrative and not restrictive. Combinations of the above embodiments and other embodiments will be apparent to those having skill in the art upon review of the present disclosure. The scope of the present invention should be determined with reference to the appended claims, along with the full scope of equivalents to which such claims are entitled.

The method of action of the present invention and prior art devices presented herein are based solely on theory. They are not intended to limit the method of action of the present invention or exclude of possible methods of action that may be present within the present invention and/or responsible for the actions of the present invention.

1-25. (canceled)

26: A method of producing an atomized spray comprising the steps of:
a Generating ultrasonic vibrations having an amplitude within a solid member at or near a resonant frequency of the solid member;
b. Delivering a liquid to be atomized to a side of the solid member;
c. Driving the liquid towards a radiation surface of the solid member using the ultrasonic vibrations; and
d. Allowing the liquid reaching the radiation surface to be atomized and propelled away from the radiation surface, as the atomized spray.

27: The method of claim 26 wherein the liquid delivery is accomplished by dripping the liquid onto the solid member.

28. The method of claim 26 wherein the liquid delivery is accomplished by flowing the liquid over the solid member.

29: The method of claim 26 wherein the liquid delivery is accomplished by positioning an orifice at a distance from the solid member such that a drop of the liquid exiting the orifice contacts the solid member before atomizing.

30: The method of claim 26 further comprising the step of focusing the atomized spray.

31: The method of claim 26 wherein the liquid has a material component and the method has the additional step of heating the atomized spray to a temperature of at least the boiling point of that material component within the liquid.

32: The method of claim 26 further comprising the step of directing the spray towards a surface to be coated.

33: The method of claim 31, ether comprising the step of collecting the material component.

34: The method of claim 26 further comprising the step of allowing a gas released from the liquid to condense.

35: The method of claim 26, further comprising the step of controlling the liquid delivery by adjusting the amplitude of the ultrasonic vibrations.

36: The method of claim 26 further comprising the step of collecting the gas released from the liquid.

37: The method of claim 26 further comprising the step of collecting the atomized spray.

38: A method of producing an atomized spray comprising the steps of:
a. Generating ultrasonic vibrations having an amplitude within a solid member at or near a resonant frequency of the solid member;
b. Delivering a liquid to be atomized to a side of the solid member; and
c. Allowing the liquid reaching the radiation surface to be atomized and propelled away from the radiation surface, as an atomized spray.

39: The method of claim 38, wherein the liquid delivery is accomplished by dripping the liquid onto the radiation surface.

40. The method of claim 38, wherein the liquid delivery is accomplished by flowing the liquid over the radiation surface.

41: The method of claim 38, wherein the liquid delivery is accomplished by, positioning an orifice at a distance from the radiation surface such that a drop of the liquid exiting the orifice contacts the radiation surface before atomizing.

42: The method of claim 38, wherein the liquid delivery is accomplished by passing the liquid through a channel opening within the radiation surface.

43: The method of claim 38, further comprising the step of focusing the atomized spray.

44: The method of claim 38, wherein the liquid has a material component and the method has the additional step of heating the atomized spray to a temperature of at least the boiling point of the material component within the liquid.

45: The method of claim 38, further comprising the step of directing the spray towards a surface to be coated.

46: The method of claim 44, further comprising the step of collecting the material component.

47: The method of claim 38, further comprising the step of allowing a gas released from the liquid to condense.

48: The method of claim 38, further comprising the step of controlling the liquid delivery by adjusting the amplitude of the ultrasonic vibrations.

49: The method of claim 38, further comprising the step of collecting the gas released from the liquid.

50. The method of claim 38, further comprising the step of collecting the atomized spray.
